(19) United States
(12) Patent Application Publication
(10) Pub. No.: US 2004/0168276 A1
(43) Pub. Date: Sep. 2, 2004

(54) Roller-typed paintbrush's structural improvement

(75) Inventor: Sheng-Ping Lye, Wuxi City (CN)

Correspondence Address: BRUCE H. TROXELL, SUITE 1404, 5205 LEESBURG PIKE, FALLS CHURCH, VA, 22041, US

(73) Assignee: WUXI PHOHANDY TOOL CO., LTD.

(21) Appl. No.: 10/373,839

(22) Filed: Feb. 27, 2003

(51) Int. Cl. B05C 17/02

(52) U.S. Cl. 15/230.11; 492/13; 492/19

(57) ABSTRACT

A roller-typed paintbrush's structural improvement is mainly comprised of a hollow grip made of plastic material and a hollow support, the first connection end of which is connected securely to the front side of the hollow grip, and another end of which is extended to left side and right side outwardly to become a first supporting arm and a second supporting arm, inside front side of both which is arranged an immovable axis; and two supporting wheels, which may be fitted into the immovable axis arranged pivotally at the first supporting arm and second supporting arm, and the inside part of both which may be inserted into the hollow roller arranged hair-sheath to be wedged in securely by a method of tight fitting, such that an objective of quick assembly or taking-apart may be achieved; since the invention is made of plastic material so, not only does it have the advantages of light weight and low cost, but also does it have the advantage of easy recycling to further fulfill environmental protection and automatic supplication of paint, such that a purpose of practical application is reached.

### 1. FIELD OF THE INVENTION

The invention relates to a roller-typed paintbrush's structural improvement, in particular to a roller-typed paintbrush's structural improvement that has a hollow structure made of plastic material and has a function to automatically supply paint material.

### 2. BACKGROUND OF THE INVENTION

Accordingly, a traditional roller-typed paintbrush (as shown in FIG. 1) is to arrange a supporting axis B bent from a metal rod in the front side of a grip A made of plastic. An immovable axis C capable of free rotation is fitted on the supporting axis B. A hollow roller E arranged a hair-sheath D over the outer surface thereof is fitted securely on the immovable axis C. Additionally, a thread hole F is arranged at the tail end of the grip A to provide a secure connection to a long extension rod H with thread G. Through aforementioned structure, a user may directly handle the grip A or apply the long extension rod H to connect the grip A to attach paint material on the hair-sheath D to proceed a rolling-and-painting job on the wall to be painted. Although above structure may reach the effects of paint attachment and painting, there are still many shortcomings to be further improved and studied in a real operational procedure. First of all, since most parts of the traditional roller-typed paintbrush, such as: supporting axis B and immovable axis C, are completely made of metal materials (except the grip A) so, not only is the manufacturing cost expensive, but also is the weight is heavier-averaged around 200 grams, and an additional weight will be added when the user attaches the paint material onto the hair-sheath of the paintbrush. Except its fast speed of painting, the most important factor for a user to select a roller-typed paintbrush is the convenience that its grip A may be connected to a long extension rod H to paint a higher place of wall. For most users who use the roller-typed paintbrush will connect a long extension rod H of different lengths to the tail end of the grip A. In such way, the problem of heavy weight of additional roller-typed paintbrush described thereinbefore will be more serious because of the operation of lever principle. Furthermore, since the traditional roller-typed paintbrush can not supply paint material automatically, so the operator has to laboriously move down the hair-sheath D of the hollow roller E arranged at the front side of the paintbrush to proceed the action of paint attachment in each sectional time. Since this kind of paintbrush is not only very inconvenient but also very laborious, so extreme inconvenience and harassment are created to the user.

Please refer to FIG. 2, which is the U.S. Pat. No. 4,077,082 patent that mainly discloses a roller frame I, which is made of plastic. One side of an end mount J arranged at the top end of the roller frame I is arranged a stub shaft K, which is connected pivotally to end cap M arranged at two sides of a roller cover support L, which is provided for a roller cover N to be fitted securely thereon to proceed a rolling-and-painting job.

The structure disclosed in aforementioned structure is made of plastic material to reduce its entire weight but, since its roller frame I is a solid structure and in lack of elasticity, so it may happen the situation of breakage or damage because of too great force during painting process. On the other hand, the prior structure still can not provide the function of automatic supplication of paint material, so the operator still has to continuously attach paint material onto the paintbrush during the painting procedure. Therefore, unnecessary time is wasted and the shortcomings of dropping paint drops to the ground and polluting other surrounding articles are arisen.

### SUMMARY OF THE INVENTION

The major objective of the invention is to provide a roller-typed paintbrush's structural improvement, which mainly includes: a hollow grip, which is made of plastic material, and a tail end of which is arranged a thread hole that can be securely connected to a long extension rod, one front side of which is arranged thread; a hollow support, which is made of plastic material, and a first connection end of which is connected securely to the front side of the hollow grip, and another end of which is extended to left and right sides outwardly to become a first supporting arm and a second supporting arm, the diameters of both which are gradually reduced along their extension directions, and inside the front sides of both which are respectively arranged an immovable axis; and two supporting wheels, center of both which is arranged an axial hole that can be fitted into the immovable axis arranged at the first supporting arm and the second supporting arm to rotate freely, and in the outside of both which a larger ring-shaped flange is arranged, and on the inside surface of both which several convex pieces are arranged in equal space partition, and inside portion of both which may be just inserted into the hollow roller arranged hair-sheath to be wedged-in securely by the tightly fitting method; because of the generalized specification of the dimension sizes of the roller attached with hair-sheath and sold in current market, so the invention may quickly assemble or dismantle the hollow roller attached with hair-sheath. Since the invention is made of plastic material, so it has the advantages of reducing entire weight and manufacture cost.

The secondary objective of the invention is to provide a roller-typed paintbrush's structural improvement, wherein the invention may further arrange several penetration holes made on the hollow roller attached with hair-sheath in the outside thereof; and cooperating with the design of a long hollow extension rod, the paint material may enter the interior of the hollow roller through the hollow portion of the long extension rod and gradually diffuse into the hair-sheath through the penetration holes arranged on the hollow roller, such that a function of automatic supplication of paint material is provided.

A further objective of the invention is to provide a roller-typed paintbrush's structural improvement, wherein the hollow grip and hollow support may be manufactured by integral projection method from plastic material, such that it has a better advantages of lower cost and convenient recycling for environmental protection.

### BRIEF DESCRIPTION OF THE DRAWINGS

FIG. 1 is an outer-appearance illustration for one prior product.

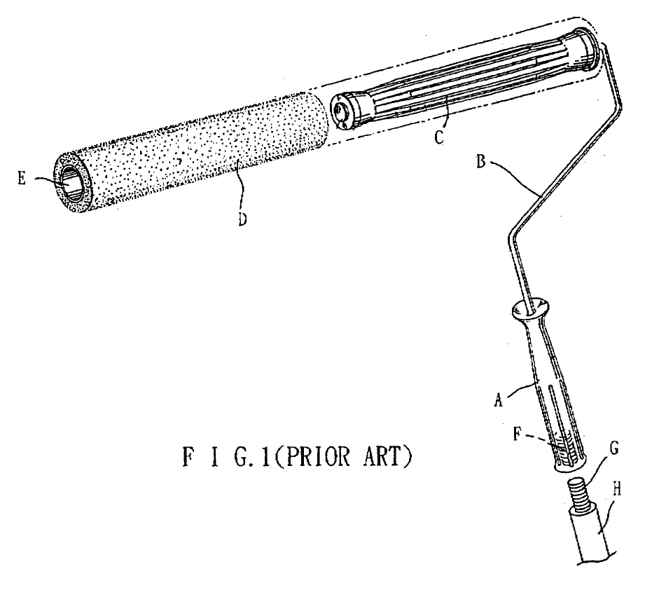

FIG. 2 is an outer-appearance illustration for another prior product.

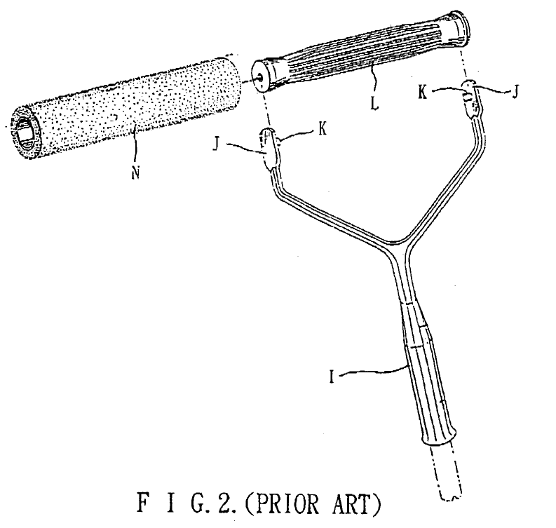

FIG. 3 is a 3-D explosive view according to the invention.

FIG. 4 is a 3-D assembling view according to the invention.

FIG. 5 is a cross-sectional view according to the invention.

FIG. 6 is a cross-sectional view for another embodiment according to the invention.

### DETAILED DESCRIPTION OF THE INVENTION

For your esteemed members of reviewing committee to further recognize and understand the characteristics, objectives, and functions of the present invention, a detailed description together with corresponding drawings are presented thereinafter.

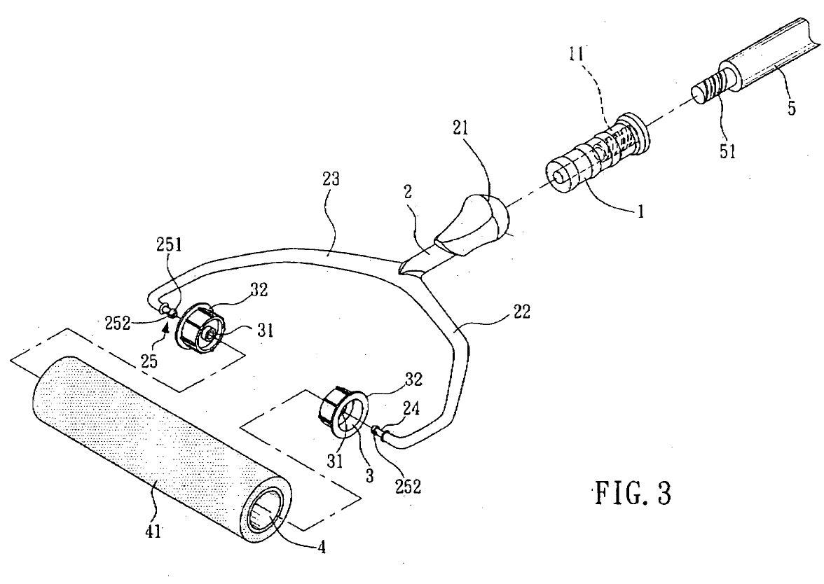

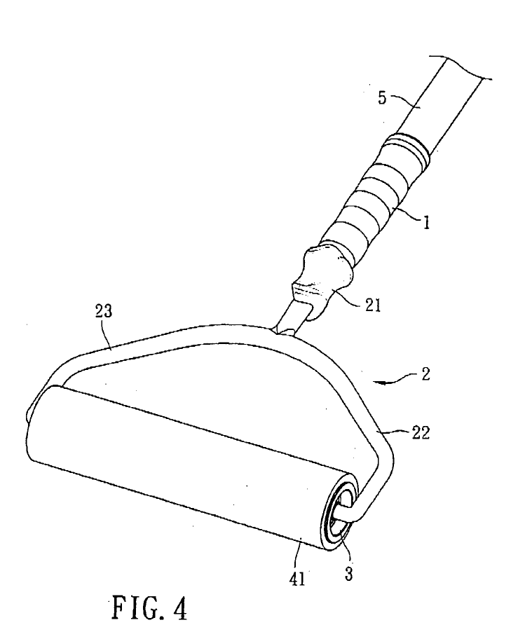

First, please your esteemed members of reviewing committee refer to FIG. 3 and FIG. 4, which are a 3-D explosive view and a 3-D assembling view for the roller-typed paintbrush's structural improvement according to the present invention, which mainly includes: a hollow grip 1, which is made of plastic material., and a tail end of which is arranged a thread hole 11 that can be securely connected to a long extension rod 5, one front side of which is arranged thread 51; a hollow support 2, which is made of plastic material, and a first connection end 21 of which is connected securely to the front side of the hollow grip 1, and another end of which is extended to left and right sides outwardly to become a first supporting arm 22 and a second supporting arm 23, the diameters of both which are gradually reduced along their extension directions, and inside the front sides of both which are respectively arranged an immovable axis 24; and two supporting wheels 3, center of both which is arranged an axial hole 31 that can be fitted into the immovable axis 24 arranged at the first supporting arm 22 and the second supporting arm 23, and in the outside of both which a larger ring-shaped flange 32 is arranged, and on the inside surface of both which several convex pieces 33 are arranged in equal space partition, and inside portion of both which may be just inserted into the hollow roller 4 arranged hair-sheath 41 to be wedged-in securely by the tightly fitting method; because of the generalized specification of the dimension sizes of the roller 4 attached with hair-sheath 41 and sold in current market, so the invention may quickly assemble or dismantle the hollow roller 4 attached with hair-sheath 41.

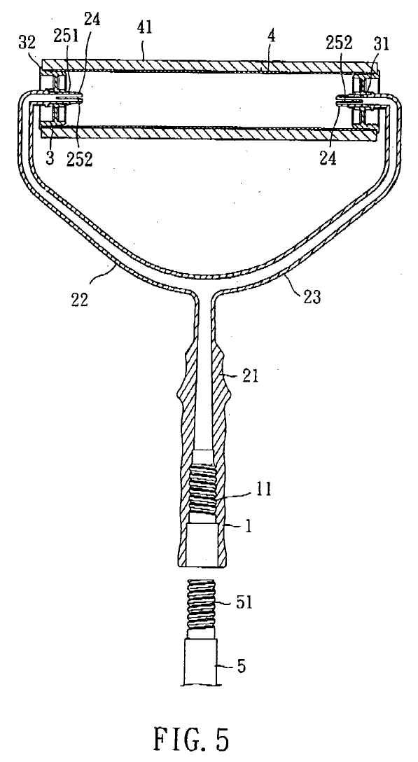

In the aforementioned structure, the connection between the hollow grip 1 and the hollow support 2 may apply the connection methods according to prior arts, such as: adhesion, and thermal-melting, etc., and it also may be made by an integral injection method from plastic material as shown in FIG. 5.

By the aforementioned structure, the user may first inset two supporting wheels 3 respectively into two sides of the hollow roller 4 having hair-sheath 41, then inserts the immovable axes 24 arranged at the front sides of both first supporting arm 22 and second supporting arm 23 into the axial holes 31 arranged on the supporting wheels 3, such that a function of instant assembly may be achieved. Except the hair-sheath 41, since the all other elements of the invention are made of plastic materials in hollow shapes and its actual weight is about 200 grams, so it may effectively reduce the entire weight to 50% of that of the prior arts. Consequently, it may greatly reduce the laboring load for a user who often uses a roller-typed paintbrush connected with a long extension rod 5 that has some degrees of lever operation. On the other hand, the hollow structure made of plastic materials may make itself possess more elasticity, so it is uneasy to occur a breaking phenomenon during force applying period.

Additionally, in the aforementioned structure, the hollow paintbrush made of plastic material will make the invention have the advantages of low cost and light weight, such that it has more competition in the market.

Since the diameters of aforementioned first supporting arm 22 and second supporting arm 23 will be gradually reduced along the extension directions of two supporting arms, such that they will have better elasticity.

Again, in the structure according to the invention, through arranging an elastic fastening structure 25 at the front side of the immovable axis 24 that is automatically fastened after it is inserted into the axial hole 31 arranged ill the supporting axis 3, a function for fixing the supporting wheel 3 and the immovable axis 24 may be achieved.

The aforementioned elastic fastening structure 25 is mainly to arrange a cone-shaped flange 251 with a larger diameter to the front side of the immovable axis 24 and arrange a cut groove 252 at the front side of cone-shaped flange 251. By the design of aforementioned structure, when both the immovable axis 24 and the supporting wheel 3 are connected together, and when the inclining surface of flange 251 in front of the immovable 24 is abutted against the edge of the axial hole 31 of the supporting wheel 3, the flange 251 will then be bent and displaced toward the direction of central cut groove 252, such that the flange 251 can pass through the axial hole 31 and then resume back to its original position by the elastic force of the material of the immovable axis 24. At this time, by the arrangement of the flange 251, it may really prevent the immovable axis 24 and the axial hole 31 of the supporting wheel 3 from separation.

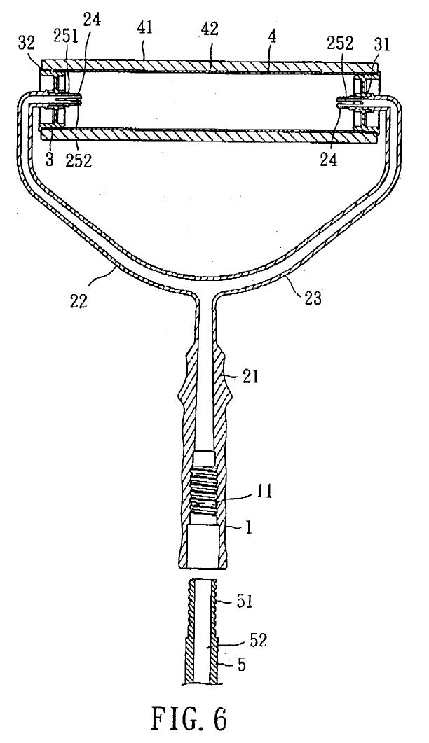

Please your esteemed members of reviewing committee continuously refer to FIG. 6, which is a cross-sectional illustration for another embodiment according to the invention, wherein the hollow portion of the invention may be extended from the tail end of the hollow grip 1 to the front side of the immovable axis, and several penetration holes 42 may be cooperatively arranged on the hollow roller 4 having hair-sheath 41 overly, and there is a hollow pipe 52 arranged at the center of the long extensive rod 5 for providing a passage of paint flow, such that the paint material can flow through the hollow pipe 52 of the long extension rod 4 and the hollow portion of the invention, and finally enter the interior of the hollow roller 4 from the front side of the immovable axis 24 and, through the penetration hole 42 arranged on the hollow roller 4, the paint material gradually diffuses into the hair-sheath 41, such that an automatic supplication of paint material is provided. By the design of above structure, the user does not need to duplicate the action of paint attachment during the painting procedure so, not only may it enhance the painting efficiency greatly, but also may it indeed solve the pollution problem caused by the paint drop occurred in the paint attaching procedure.

From above description, it may easily find that the U.S. Pat. No. 4,077,082 patent had disclosed a roller-typed paintbrush's structure made of plastic material, but the hollow structure firstly disclosed by the present invention, the design of gradual contraction of the diameter of the extensive supporting arm, and an extremely small supporting wheel 3 replacing the roller cover support having relatively large volume may not only reduce the entire weight, but also make the structure of the invention have better elasticity and be uneasy to break off. Most important of all, by arranging several penetration holes 42 on the hollow roller 4 having hair-sheath 41 overly, the invention has a function, of automatic supplication of paint material, unavailable in the products according to the prior arts; thereby, the laboring load of operator is reduced greatly and the efficiency of painting is enhanced additionally.

What is claimed is:

1. A roller-typed paintbrush's structural improvement, which mainly includes:
a hollow grip, which is made of plastic material, and a tail end of which is arranged a thread hole that can be securely connected to a long extension rod, one front side of which is arranged thread;
a hollow support, which is made of plastic material, and a first connection end of which is connected securely to the front side of the hollow grip, and another end of which is extended to left and right sides outwardly to become a first supporting arm and a second supporting arm, inside the front sides of both which are respectively arranged a immovable axis;
a hollow roller, over outer surface of which is fitted a hair-sheath that can attach paint material; and
two supporting wheels, center of both which is arranged an axial hole that can be fitted into the immovable axis arranged at the first supporting arm and the second supporting arm, and in the outside edge of both which a larger ring-shaped flange is arranged, and on the inside surface of both which several convex pieces are arranged in equal space partition, and inside portion of both which may be just inserted into the hollow roller arranged the hair-sheath to be wedged-in securely by a tightly fitting method.

2. The roller-typed paintbrush's structural improvement according to claim 1, wherein the diameters of the first supporting arm and the second supporting arm are gradually reduced along their extension directions.

3. The roller-typed paintbrush's structural improvement according to claim 1, wherein the connection between the hollow grip and the hollow support may apply the connection methods according to the prior arts, such as: adhesion, and thermal-melting, etc.

4. The roller-typed paintbrush's structural improvement according to claim 1, wherein an integral injection method with plastic material may be manufactured between the hollow grip and the hollow support.

5. The roller-typed paintbrush's structural improvement according to claim 1, wherein the front side of the immovable axis may be arranged an elastic fastening structure that can be automatically fastened after the immovable axis is inserted into the axial hole arranged at the supporting wheel.

6. The roller-typed paintbrush's structural improvement according to claim 5, wherein the elastic fastening structure is a cone-shaped flange arranged at the front side of the immovable axis, and there is a cut groove arranged at the front side of the cone-shaped flange.

7. The roller-typed paintbrush's structural improvement according to claim 1, wherein the hollow part of the invention is extended from the tail end of the grip to the front side of the immovable axis and, at same time, cooperating with several penetration holes arranged on the hollow rollers covered with hair-sheath overly, there is a hollow pipe arranged in the center of the long extension rod for providing flowing passage for supplying the paint materials.
